(19) United States
(12) Patent Application Publication
(10) Pub. No.: US 2015/0276136 A1
(43) Pub. Date: Oct. 1, 2015

(54) MINIMALISTIC LED RECESSED LIGHT

(71) Applicant: SKYNET ELECTRONIC CO., LTD., Taipei (TW)

(72) Inventor: Jim-Hung LIANG, Taipei (TW)

(73) Assignee: SKYNET ELECTRONIC CO., LTD., Taipei (TW)

(21) Appl. No.: 14/293,509

(22) Filed: Jun. 2, 2014

(30) Foreign Application Priority Data
Mar. 27, 2014 (TW) 103111433

(51) Int. Cl. F21K 99/00; F21S 8/02; F21V 29/74; F21V 7/00; F21V 29/70; F21V 21/14

(52) U.S. Cl. CPC F21K 9/135; F21K 9/54; F21V 29/70; F21V 21/14; F21V 29/74; F21V 7/0066; F21S 8/02; F21Y 2101/02

(57) ABSTRACT

The present invention is to provide a minimalistic LED recessed light, which includes a light cup having a bottom provided with an opening and a top provided with a light-permeable hole in communication with the opening, a light chip having a bottom surface provided with at least one LED, a heat sink having a bottom connected with the top of the light cup for positioning the light chip therebetween and allowing the LED to correspond in position to the light-permeable hole, and an elastic supporting plate fixed to a top of the heat sink and having sections respectively and symmetrically bent toward the light cup and formed with an outwardly curved engaging surface, wherein the distance between the curved engaging surfaces is greater than a diameter of a fitting hole cut in a ceiling, for effectively achieving the objects of heat dissipation and easy installation/removal of the recessed light.

### FIELD OF THE INVENTION

The present invention is to provide a minimalistic LED recessed light, which includes a light cup having a bottom provided with an opening and a top provided with a light-permeable hole in communication with the opening, a light chip having a bottom surface provided with at least one LED, a heat sink having a bottom connected with the top of the light cup for allowing the light chip to be positioned between the light cup and heat sink and allowing the LED to correspond in position to the light-permeable hole, and an elastic supporting plate fixed to a top of the heat sink and having sections respectively and symmetrically bent toward the light cup and formed with an outwardly curved engaging surface, wherein the distance between the curved engaging surfaces is greater than a diameter of a fitting hole cut in a ceiling. Thus, since the structure of the recessed light is extremely simple, the volume and weight of the recessed light are greatly reduced in comparison with its prior art counterparts and the objects of heat dissipation and easy installation/removal of the recessed light can be effectively achieved.

### BACKGROUND OF THE INVENTION

FIG. 1 shows a conventional recessed light 10, also known as a down light, which is fitted in a fitting hole 141 cut in a ceiling 14. The recessed light 10 includes a light cup 11. The bottom of the light cup 11 is provided with an opening 111. The light cup 11 defines a receiving space therein in which a light-emitting element (not shown) can be mounted. The periphery of the bottom of the light cup 11 is formed with an annular flange 113 which extends radially outward. The top edge of the light cup 11 has a peripheral wall symmetrically provided with two pivotal connection bases 114. Each of the pivotal connection bases 114 is mounted with a torsion spring 13. Each torsion spring 13 has one end (hereinafter referred to as the first end) passing through the corresponding pivotal connection base 114 and fixed to the top edge of the light cup 11 and has an opposite end (hereinafter referred to as the second end) which, when not subjected to an external force, tends to rotate away from the first end of the torsion spring 13 due to the elastic stress of the torsion spring 13. Therefore, the mounting of the conventional recessed light 10 into the fitting hole 141 must begin by pushing, or more particularly rotating, the second end of each torsion spring 13 toward the corresponding first end. Then, the top of the light cup 11 is put into the fitting hole 141. As soon as the pushing force applied to the torsion springs 13 is removed, the second end of each torsion spring 13 rotates away from the corresponding first end due to the elastic stress of the torsion spring 13 and presses against the top surface of the ceiling 14, thereby generating an upward supporting force for the recessed light 10. Consequently, the recessed light 10 is positioned in the fitting hole 141 by means of the supporting force, and the gap between the fitting hole 141 and the peripheral wall of the light cup 11 is covered by the annular flange 113.

As stated above, once the conventional recessed light 10 is mounted in the fitting hole 141, the second ends of the torsion springs 13 press elastically against the top surface of the ceiling 14. Moreover, a top surface portion and a bottom surface portion of the ceiling 14 are clamped between the second ends of the torsion springs 13 and the annular flange 113, which corresponds in position to the second ends of the torsion springs 13. Therefore, although one wishing to remove the conventional recessed light 10 from the fitting hole 141 has to rotate the second ends of the torsion springs 13 toward their respective first ends to remove the supporting force applied by the torsion springs 13 to the recessed light 10, the torsions springs 13 are blocked by the ceiling 14 and cannot be reached. To remove the recessed light 10, there is no other way than to forcibly pull the portion of the recessed light 10 that is exposed from the fitting hole 141 (i.e., the annular flange 113), thereby applying a downward pulling force to the first ends of the torsion springs 13. The second ends of the torsion springs 13 will turn upward when subjected to the reaction force of the ceiling 14, and the supporting force generated by the second ends of the torsion springs 13 for the recessed light 10 is thus eliminated, allowing the recessed light 10 to be removed from within the fitting hole 141. However, pulling the annular flange 113 by force tends to damage the rim of the fitting hole 141, leaving a large mount of wood chips and dust at the site. In addition, the instant at which the second ends of the torsion springs 13 leave the hole wall of the fitting hole 141, the elastic stress accumulated in the torsion springs 13 will drive the second ends of the torsion springs 13 into violent rotation away from their respective first ends, and the operator's fingers or palm may be pinched as a result. It can be clearly known from the above that the conventional recessed light 10 not only is structurally complicated, which incurs high production costs, but also is difficult to install and remove. Moreover, the laborious and time-consuming removing procedure tends to cause pinch injury to the operator's fingers or palm and irrevocable damage to the fitting hole 141.

In view of the foregoing problems, the inventor of the present invention designed and developed the recessed light structure shown in FIG. 2. The recessed light 20 includes a light cup 21 and at least two elastic supporting plates 22. The bottom of the light cup 21 is provided with an opening 211. The light cup 21 defines a receiving space 212 therein in which a light-emitting element 23 is mounted. The light-emitting element 23 may be a light-emitting diode (LED) light chip or light bulb, an incandescent light bulb, a fluorescent light bulb, or other light bulbs. The light cup 21 has a periphery which is adjacent to the opening 211 and which extends radially outward; consequently, an annular flange 213 is formed along the bottom periphery of the light cup 21. Each elastic supporting plate 22 is formed by bending an elastic metal plate and has a front section, a middle section, and a rear section. The front sections of the elastic supporting plates 22 are symmetrically and fixedly connected to the peripheral wall of the light cup 21. The middle sections of the elastic supporting plates 22 extend upward and each terminate with a downwardly bent tail end, which further extends to form the rear section of the corresponding elastic supporting plate 22. The rear section of each elastic supporting plate 22 and the tangent of the tail end of the corresponding middle section form an included angle. To mount the recessed light 20 into a fitting hole 241 cut in a ceiling 24, the operator only has to press the rear sections of the elastic supporting plates 22 of the light cup 21, bringing the front and rear sections of each elastic supporting plate 22 close to each other, and then put the top of the light cup 21 into the fitting hole 241. Once the pressing force applied to the elastic supporting plates 22 is removed, the elastic stress of the elastic supporting plates 22 drives the outer surface of the rear section of each elastic supporting plate 22 away from the peripheral wall of the light cup 21 and into tight engagement with the hole wall of the fitting hole 241. Thus, the recessed light 20 is securely mounted in the fitting hole 241 thanks to the friction between the outer surface of the rear section of each elastic supporting plate 22 and the hole wall of the fitting hole 241, and the gap between the fitting hole 241 and the peripheral wall of the light cup 21 is covered by the annular flange 213.

As the production costs of high-brightness LEDs decrease with time, there has been a market trend to produce LED recessed lights, which incorporate LEDs as their light-emitting elements and are both environmentally friendly and energy saving. However, when the structure shown in FIG. 2 is actually used to make an LED recessed light, heat dissipation issues arise. As is well known in the art, LEDs generate a significant amount of heat during light emission, and yet the light cup 21 of the recessed light 20 completely encloses the light-emitting element 23 (i.e., an LED light chip or circuit board, even including the heat sink mounted thereon) from the top side. In consequence, the light cup 21 fails to dissipate the heat generated by the light-emitting element 23, and the temperature of the light-emitting element 23 stays high. Should the light-emitting element 23 remain in a high-temperature state for a long time, the materials of the light-emitting element 23 are subject to severe aging problems, and significant emission decay may result, meaning the service life of the light-emitting element 23 may be greatly reduced.

To solve the aforesaid problems, new LED recessed light structures were developed in the industry, but most of these structures still use the basic constructions of the two recessed lights described above. In some cases, structural complexity is even increased with the use of heat sinks, which lead to not only high production costs and hence consumer-unfriendly selling prices, but also bulky, heavy, and difficult-to-install LED recessed lights. In the end, commercially available LED recessed lights are left on store shelves, waiting for a chance to realize their intended environmental benefits and energy-saving effects.

Therefore, the issue to be addressed by the present invention is to design an innovative, minimalistic LED recessed light which, in addition to effectively overcoming the aforementioned problems of the conventional recessed lights, features rapid production, easy assembly, convenient installation into (or removal from) a fitting hole, and fast heat dissipation.

### BRIEF SUMMARY OF THE INVENTION

It is an object of the present invention to provide a minimalistic LED recessed light, wherein the recessed light includes a light cup, a light chip, a heat sink, and an elastic supporting plate. The bottom of the light cup is provided with an opening. The light cup defines a reflective space therein. The top of the light cup is provided with a light-permeable hole in communication with the reflective space and the opening. The light cup has a periphery which is adjacent to the opening and which is formed with a radially outwardly extending annular flange. The light cup further has a periphery which is adjacent to the light-permeable hole and which is formed with a first connecting structure. The outer diameter of the annular flange is greater than the diameter of a fitting hole while the outer diameter of the rest of the light cup is less than the diameter of the fitting hole. The bottom surface of the light chip is provided with at least one LED corresponding in position to the light-permeable hole. The top surface of the light chip is provided with at least two pins electrically connected to the LED. The bottom of the heat sink is provided with a second connecting structure. The second connecting structure can connect with the first connecting structure so that the light cup and the heat sink are assembled together, with the light chip positioned between the light cup and the heat sink. The greatest outer diameter of the heat sink is less than the diameter of the fitting hole. The elastic supporting plate is formed by bending an elastic plate. The elastic supporting plate has a middle section fixed to the heat sink. The left and right sections of the elastic supporting plate are respectively and symmetrically bent toward the light cup and are each formed with an outwardly curved engaging surface. The distance between the curved engaging surfaces is greater than the diameter of the fitting hole. The length of the middle section is less than the diameter of the fitting hole. The free ends of the left and right sections correspond in position to each other and are adjacent to the top surface of the annular flange. To mount the recessed light into the fitting hole, which is cut in a ceiling, the top of the recessed light is aligned with the fitting hole while the annular flange is held with fingers. Then, the recessed light can be easily fitted into the fitting hole by applying to the recessed light a force that acts toward the ceiling. With the light chip in contact with the heat sink, and the heat sink completely exposed at the top of the light cup, the large amount of heat generated by the LED on the light chip during light emission can dissipate upward rapidly through the heat sink, allowing the working temperature of the LED to stay in the optimal range. Thus, the LED not only can retain its optimal color temperature but also is effectively kept from material aging and emission decay; consequently, the service life of the LED is significantly extended. In addition, as the structure of the recessed light is extremely simple, the volume and weight of the recessed light are greatly reduced in comparison with its prior art counterparts. Therefore, when the curved engaging surfaces formed on the outer sides of the left and right sections of the elastic supporting plate press against the upper edge of the fitting hole, the elastic supporting plate only has to exert a very small amount of elastic force in order for the upper edge of the fitting hole to generate an upward reaction force great enough to keep the recessed light securely and evenly mounted in the fitting hole. When it is desired to remove the recessed light from the ceiling, all that needs to be done is to grip the annular flange with fingers and apply a downward force to the annular flange. Thanks to the elasticity of the elastic supporting plate and the curvature of the curved engaging surfaces, the recessed light can be readily disengaged from the fitting hole. Thus, the object of providing a minimalistic structure that enables heat dissipation and easy installation/removal of the recessed light is effectively achieved.

Another object of the present invention is to provide the foregoing recessed light, wherein the recessed light includes at least two elastic supporting plates. Each of the elastic supporting plates is formed by bending an elastic plate and has one end fixed to the heat sink and an opposite end which is bent toward the light cup and which extends to the vicinity of the top surface of the annular flange. Also, each of the elastic supporting plates is formed with an outwardly curved engaging surface. The distance between the curved engaging surfaces is greater than the diameter of the fitting hole.

### BRIEF DESCRIPTION OF THE SEVERAL VIEWS OF THE DRAWINGS

The above and other objects, as well as the technical features and their effects, of the present invention will be best understood by referring to the following detailed description of some illustrative embodiments in conjunction with the accompanying drawings, in which:

FIG. 1 is a schematic drawing of a conventional recessed light structure;

FIG. 2 is a schematic drawing of a conventional recessed light structure previously designed by the inventor of the present invention;

FIG. 3 is an exploded sectional view of the first preferred embodiment of the present invention;

FIG. 4 is an assembled schematic view of the first preferred embodiment of the present invention;

FIG. 5 is a top schematic view of the first preferred embodiment of the present invention; and

FIG. 6 is an assembled schematic view of the second preferred embodiment of the present invention.

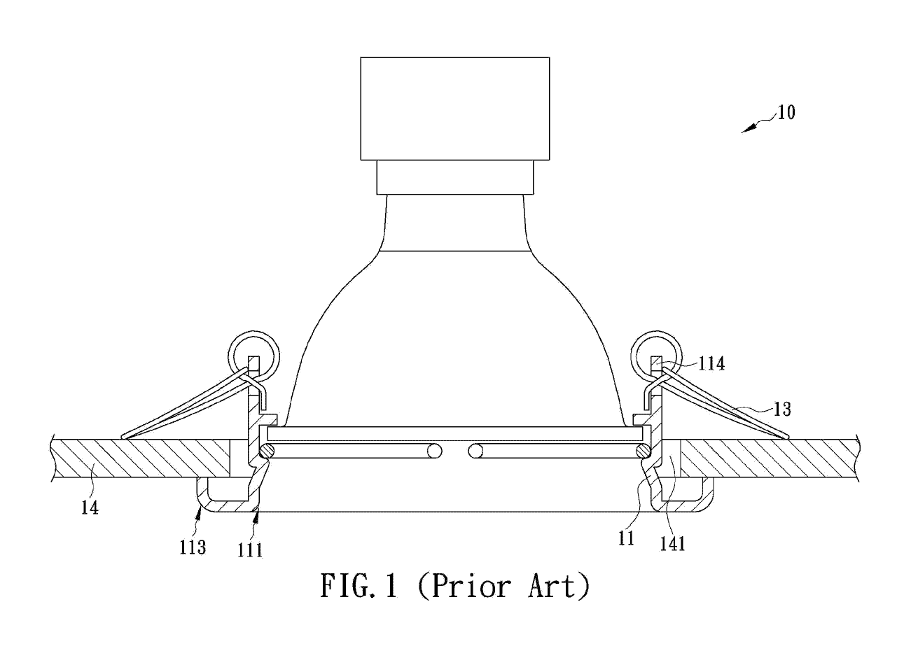

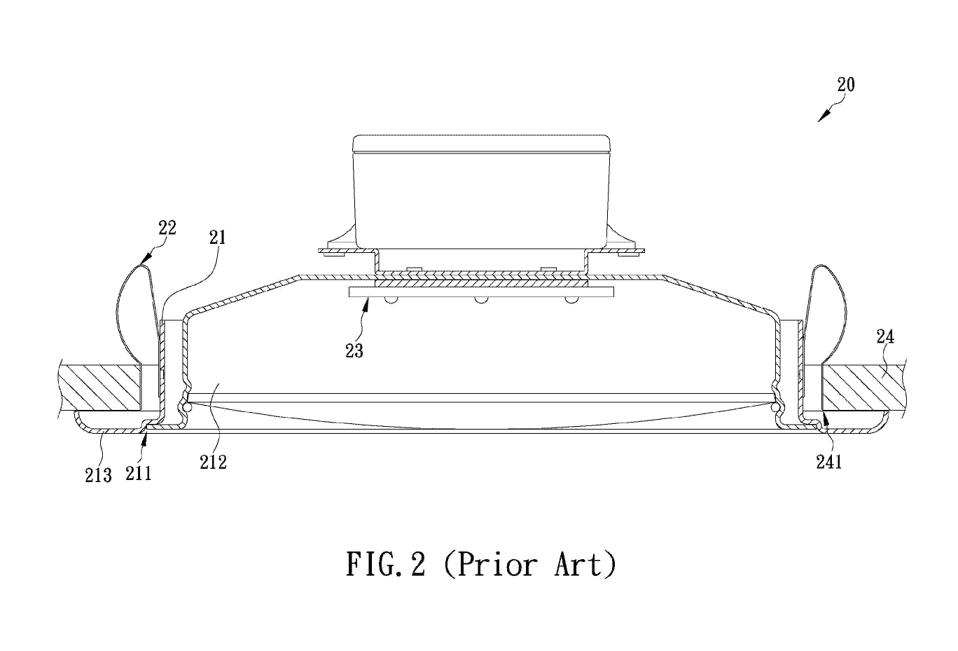

### DETAILED DESCRIPTION OF THE INVENTION

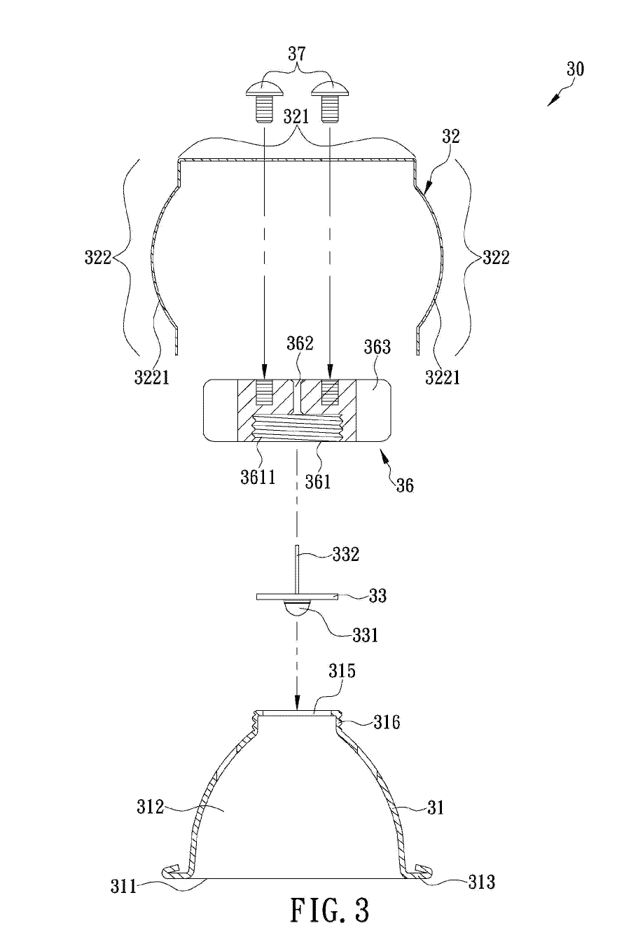

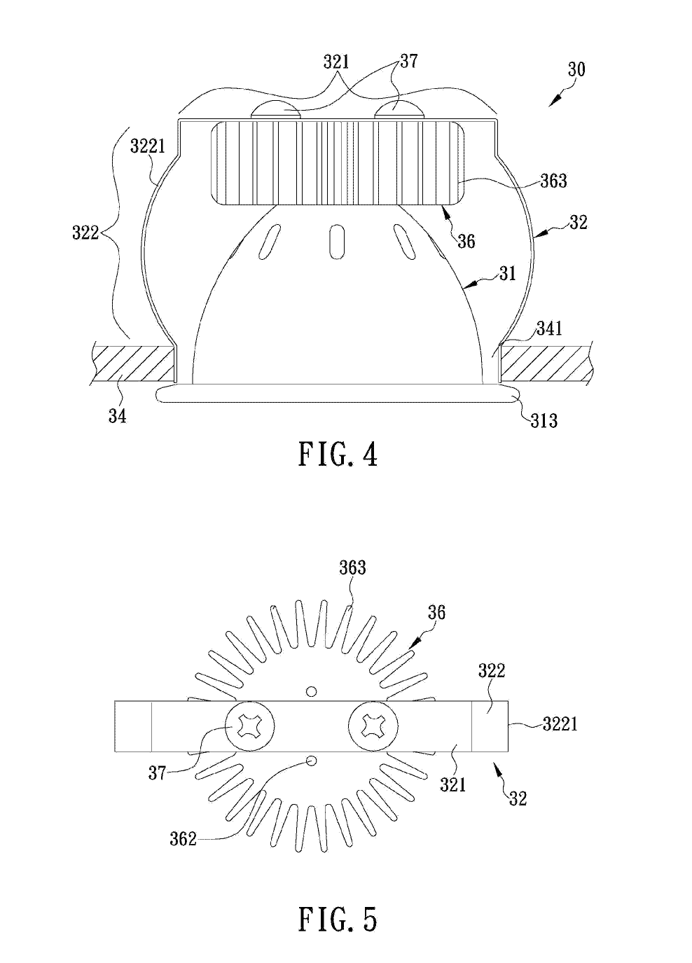

In the first preferred embodiment of the present invention as shown in FIG. 3, the minimalistic LED recessed light 30 includes a light cup 31, a light chip 33, a heat sink 36, and an elastic supporting plate 32. The bottom of the light cup 31 is provided with an opening 311. The light cup 31 defines a reflective space 312 therein. The top of the light cup 31 is provided with a light-permeable hole 315. The opening 311, the reflective space 312, and the light-permeable hole 315 are in communication with one another. The light cup 31 has a periphery which is adjacent to the opening 311 and which extends radially outward to form an annular flange 313. Herein, the term “annular” refers to a rectangular shape, a circular shape, a wavy ring shape, or other ring-shaped configurations. The light cup 31 further has a periphery which is adjacent to the light-permeable hole 315 and which is formed with a first connecting structure 316. The first connecting structure 316 may be an external thread or a tenon. Referring to FIG. 4, the outer diameter of the annular flange 313 is greater than the diameter of a fitting hole 341 cut in a ceiling 34. The outer diameter of the rest of the light cup 31 is less than the diameter of the fitting hole 341.

Referring back to FIG. 3, the light chip 33 is positioned at the top of the light cup 31. The bottom surface of the light chip 33 is provided with at least one LED 331 which corresponds in position to the light-permeable hole 315. The top surface of the light chip 33 is provided with at least two pins 332 which are electrically connected to the LED 331 to enable power supply to, and consequently light emission by, the LED 331. The light emitted by the LED 331 can pass through the light-permeable hole 315 and be refracted and reflected in the reflective space 312, before projecting out of the opening 311.

With continued reference to FIG. 3 and FIG. 4, the bottom of the heat sink 36 is formed with a connecting hole 361, and the connecting hole 361 is internally formed with a second connecting structure 3611. The second connecting structure 3611, which may be an internal thread or an engaging groove, can connect with the first connecting structure 316 so that the light cup 31 and the heat sink 36 are assembled together. Once assembled, the light chip 33 is positioned between the light cup 31 and the heat sink 36, and the top surface of the light chip 33 lies against a portion in the heat sink 36 that corresponds in position to the connecting hole 361. As shown in FIG. 3, FIG. 4, and FIG. 5, the heat sink 36 has an outer periphery provided with a plurality of radially extending heat-dissipating fins 363 to increase the heat dissipation area of the heat sink 36. As shown in FIG. 3 and FIG. 5, the heat sink 36 is further formed with at least one wiring hole 362 through which a wire (not shown) can pass to electrically connect with and supply electricity to the pins 332. The heat sink 36 is so configured that it can pass through the fitting hole 341. Preferably, the greatest outer diameter of the heat sink 36 is less than the diameter of the fitting hole 341.

Referring again to FIG. 3, FIG. 4, and FIG. 5, the elastic supporting plate 32, which is formed by bending an elastic plate, has a middle section 321 fixed to the top or the bottom of the heat sink 36. The left and right sections 322 of the elastic supporting plate 32 are respectively bent toward the light cup 31 and are each formed with an outwardly curved engaging surface 3221. The distance between the curved engaging surfaces 3221 is greater than the diameter of the fitting hole 341. The length of the middle section 321 of the elastic supporting plate 32 is less than the diameter of the fitting hole 341. The free ends of the left and right sections 322 of the elastic supporting plate 32 correspond in position to each other and are adjacent to the top surface of the annular flange 313.

Referring to FIG. 4, when it is desired to mount the recessed light 30 into the fitting hole 341 cut in the ceiling 34, the operator only has to hold the annular flange 313 with his or her fingers, align the top of the recessed light 30 with the fitting hole 341, and then apply to the recessed light 30 a force that acts toward the ceiling 34. By doing so, the recessed light 30 can be easily fitted into the fitting hole 341. Referring back to FIG. 3, as the light chip 33 is in contact with the heat sink 36, and the outer periphery of the heat sink 36 is completely exposed at the top of the light cup 31, the large amount of heat generated by the LED 331 on the light chip 33 during light emission can rapidly dissipate upward through the heat sink 36, allowing the working temperature of the LED 331 to stay in the optimal range, which not only enables the LED 331 to maintain its optimal color temperature but also effectively prevents material aging and emission decay; thus, the service life of the LED 331 is greatly extended. In addition, with the curved engaging surfaces 3221 on the outer sides of the left and right sections 322 of the elastic supporting plate 32 pressing against the upper edge of the fitting hole 341, the recessed light 30 is securely and evenly mounted in the fitting hole 341. Moreover, the annular flange 313, whose outer diameter is greater than the diameter of the fitting hole 341, can cover the burrs, if any, around the rim of the fitting hole 341 and the gap between the hole wall of the fitting hole 341 and the outer wall of the light cup 31; in other words, the annular flange 313 provides a decorative effect. When it is desired to remove the recessed light 30 from the ceiling 34, the operator only has to grip the annular flange 313 with his or her fingers and pull downward, and the recessed light 30 will readily disengage from the fitting hole 341, thanks to the elasticity of the elastic supporting plate 32 and the curvature of the curved engaging surfaces 3221. Thus, the object of providing a minimalistic recessed light structure that enables heat dissipation and easy installation/removal is effectively achieved.

In the first preferred embodiment of the present invention as shown in FIG. 3, FIG. 4, and FIG. 5, the middle section 321 of the elastic supporting plate 32 is fastened to the top of the heat sink 36 by at least one screw 37. In another embodiment of the present invention, however, the middle section 321 of the elastic supporting plate 32 may be fixedly connected to the bottom or a lateral wall of the heat sink 36 by riveting, mechanical engagement, welding, or otherwise.

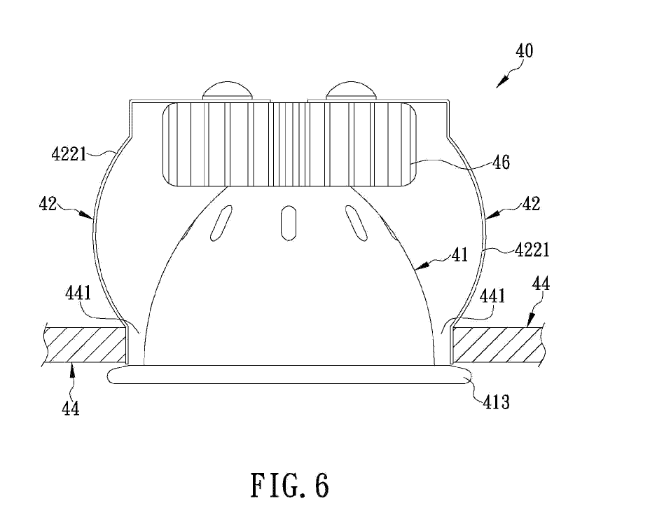

Referring now to FIG. 6 for the second preferred embodiment of the present invention, the LED recessed light 40 in this embodiment is different from the LED recessed light 30 in the first preferred embodiment in that the former includes at least two elastic supporting plates 42. Each of the elastic supporting plates 42 is formed by bending an elastic plate and has one end fixed to the top (or the bottom or a lateral wall) of the heat sink 46. The opposite end of each elastic supporting plate 42 is bent toward the light cup 41 and extends to the vicinity of the top surface of the annular flange 413. Also, each of the elastic supporting plates 42 is formed with an outwardly curved engaging surface 4221. The distance between the curved engaging surfaces 4221 is greater than the diameter of the fitting hole 441.

As stated above, referring to FIG. 4 and FIG. 6, the free ends of the elastic supporting plate(s) 32, 42 extend to the vicinity of the top surface of the annular flange 313, 413. Therefore, in the course in which the recessed light 30, 40 is mounted into the fitting hole 341, 441, the curved engaging surfaces 3221, 4221 are squeezed and deformed toward the light cup 31, 41 upon contact with the lower edge of the fitting hole 341, 441 due to the elasticity of the material of the elastic supporting plate(s) 32, 42. Once passing through the fitting hole 341, 441, the curved engaging surfaces 3221, 4221 resume their original shapes, with the distance between the cured engaging surfaces 3221, 4221 greater than the diameter of the fitting hole 341, 441. Thus, the portions of the curved engaging surfaces 3221, 4221 that are adjacent to the free ends of the elastic supporting plate(s) 32, 42 press evenly and tightly against the upper edge of the fitting hole 341, 441 due to the elasticity of the material of the elastic supporting plate(s) 32, 42, and the upper edge of the fitting hole 341, 441 applies an upward reaction force to the recessed light 30, 40. This upward reaction force is great enough to overcome the weight of the minimalistic recessed light 30, 40 such that the recessed light 30, 40 is firmly and evenly positioned in the fitting hole 341, 441. More specifically, the curvature of the curved engaging surfaces 3221, 4221 and the length(s) of the elastic supporting plate(s) 32, 42 must match the thickness of the ceiling 34, 44 and the diameter of the fitting hole 341, 441 in order for the upward reaction force generated by the upper edge of the fitting hole 341, 441 to be able to support the weight of the recessed light 30, 40.

Referring again to FIG. 4 and FIG. 6, when it is desired to remove the recessed light 30, 40 from within the fitting hole 341, 441, all that needs to be done is to grip the annular flange 313, 413 with fingers and apply a downward force to the annular flange 313, 413. When in contact with the upper edge of the fitting hole 341, 441, the curved engaging surfaces 3221, 4221 are squeezed and deformed toward the light cup 31, 41 due to the elasticity of the material of the elastic supporting plate(s) 32, 42. Once passing through the fitting hole 341, 441, the curved engaging surfaces 3221, 4221 resume their original shapes and thereby push the lower edge of the fitting hole 341, 441. As a result, the lower edge of the fitting hole 341, 441 applies a downward reaction force to the recessed light 30, 40, allowing the recessed light 30, 40 to disengage from the fitting hole 341, 441 with ease and thus facilitating removal of the recessed light 30, 40.

While the invention herein disclosed has been described by means of specific embodiments, numerous modifications and variations could be made thereto by those skilled in the art without departing from the scope of the invention set forth in the claims.

What is claimed is:

1. A minimalistic light-emitting diode (LED) recessed light, comprising:
a light cup having a bottom provided with an opening, the light cup defining a reflective space therein, the light cup having a top provided with a light-permeable hole, wherein the opening, the reflective space, and the light-permeable hole are in communication with one another, the light cup having a periphery which is adjacent to the opening and is formed with a radially outwardly extending annular flange, the light cup further having a periphery which is adjacent to the light-permeable hole and is formed with a first connecting structure, the annular flange having an outer diameter greater than a diameter of a fitting hole while the rest of the light cup has an outer diameter less than the diameter of the fitting hole;
a light chip positioned at the top of the light cup, the light chip having a bottom surface provided with at least one LED corresponding in position to the light-permeable hole, the light chip having a top surface provided with at least two pins electrically connected to the LED;
a heat sink configured to be able to pass through the fitting hole, the heat sink having a bottom provided with a second connecting structure, the second connecting structure being connectable with the first connecting structure so that the light cup and the heat sink are assembled together, with the light chip positioned between the light cup and the heat sink; and
an elastic supporting plate formed by bending an elastic plate, the elastic supporting plate having a middle section fixed to the heat sink, the elastic supporting plate having left and right sections respectively bent toward the light cup, each of the left and right sections being formed with an outwardly curved engaging surface, a distance between the curved engaging surfaces being greater than the diameter of the fitting hole, the middle section having a length less than the diameter of the fitting hole, the left and right sections having free ends which correspond in position to each other and are adjacent to a top surface of the annular flange.

2. The recessed light of claim 1, wherein the curved engaging surfaces have such a curvature that, once the recessed light is mounted in the fitting hole, an outer surface portion of each said curved engaging surface presses evenly and tightly against an upper edge of the fitting hole.

3. The recessed light of claim 2, wherein the heat sink has an outer periphery provided with a plurality of heat-dissipating fins.

4. The recessed light of claim 3, wherein the heat sink is formed with at least one wiring hole through which a power line passes to electrically connect with the pins.

5. The recessed light of claim 4, wherein the middle section of the elastic supporting plate is fixed to a top or the bottom of the heat sink.

6. The recessed light of claim 5, wherein the bottom of the heat sink is formed with a connecting hole, and the second connecting structure is formed in the connecting hole.

7. The recessed light of claim 6, wherein once the light cup and the heat sink are assembled together, with the light chip positioned between the light cup and the heat sink, the top surface of the light chip lies against a portion in the heat sink that corresponds in position to the connecting hole.

8. The recessed light of claim 7, wherein the heat sink has a greatest outer diameter less than the diameter of the fitting hole.

9. A minimalistic light-emitting diode (LED) recessed light, comprising:
a light cup having a bottom provided with an opening, the light cup defining a reflective space therein, the light cup having a top provided with a light-permeable hole, wherein the opening, the reflective space, and the light-permeable hole are in communication with one another, the light cup having a periphery which is adjacent to the opening and is formed with a radially outwardly extending annular flange, the light cup further having a periphery which is adjacent to the light-permeable hole and is formed with a first connecting structure, the annular flange having an outer diameter greater than a diameter of a fitting hole while the rest of the light cup has an outer diameter less than the diameter of the fitting hole;
a light chip positioned at the top of the light cup, the light chip having a bottom surface provided with at least one LED corresponding in position to the light-permeable hole, the light chip having a top surface provided with at least two pins electrically connected to the LED;
a heat sink configured to be able to pass through the fitting hole, the heat sink having a bottom provided with a second connecting structure, the second connecting structure being connectable with the first connecting structure so that the light cup and the heat sink are assembled together, with the light chip positioned between the light cup and the heat sink; and
at least two elastic supporting plates, each formed by bending an elastic plate, each said elastic supporting plate having an end fixed to the heat sink and an opposite end which is bent toward the light cup and extends to a vicinity of a top surface of the annular flange, each said elastic supporting plate being formed with an outwardly curved engaging surface, a distance between the curved engaging surfaces being greater than the diameter of the fitting hole.

10. The recessed light of claim 9, wherein the curved engaging surfaces have such a curvature that, once the recessed light is mounted in the fitting hole, an outer surface portion of each said curved engaging surface presses evenly and tightly against an upper edge of the fitting hole.

11. The recessed light of claim 10, wherein the heat sink has an outer periphery provided with a plurality of heat-dissipating fins.

12. The recessed light of claim 11, wherein the heat sink is formed with at least one wiring hole through which a power line passes to electrically connect with the pins.

13. The recessed light of claim 12, wherein the end of each said elastic supporting plate is fixed to a top, the bottom, or a lateral wall of the heat sink.

14. The recessed light of claim 13, wherein the bottom of the heat sink is formed with a connecting hole, and the second connecting structure is formed in the connecting hole.

15. The recessed light of claim 14, wherein once the light cup and the heat sink are assembled together, with the light chip positioned between the light cup and the heat sink, the top surface of the light chip lies against a portion in the heat sink that corresponds in position to the connecting hole.

16. The recessed light of claim 15, wherein the heat sink has a greatest outer diameter less than the diameter of the fitting hole.
